(19) United States
(12) Patent Application Publication
(10) Pub. No.: US 2016/0014177 A1
(43) Pub. Date: Jan. 14, 2016

(54) CIM/E AND CIM/G-BASED GRAPHICS-MODEL-INTEGRATED APPARATUS AND METHOD FOR DISTRIBUTION NETWORK

(71) Applicants: State Grid Suzhou Power Supply Company, Suzhou (CN); State Grid Jiangsu Electric Power Company, Nanjing (CN); State Grid Corporation of China, Beijing (CN); State Grid Electric Power Research Institute, Nanjing (CN)

(72) Inventors: Bing Han, Suzhou (CN); Zhichang Zhang, Suzhou (CN); Jiaqing Zhao, Suzhou (CN); Hongwei Du, Nanjing (CN); Yi Wu, Nanjing (CN); Zhihong Yang, Nanjing (CN); Hongen Ding, Suzhou (CN); Chongpu Xia, Nanjing (CN); Kejun Qian, Suzhou (CN); Yanghao Zhou, Nanjing (CN); Haibing Zhu, Nanjing (CN); Fan Liu, Nanjing (CN); Yi Liu, Nanjing (CN)

(21) Appl. No.: 14/797,028

(22) Filed: Jul. 10, 2015

(30) Foreign Application Priority Data
Jul. 11, 2014 (CN) 201410331316.9

(51) Int. Cl. H04L 29/06

(52) U.S. Cl. CPC H04L 65/60; H04L 69/16

(57) ABSTRACT

This invention discloses a CIM/E (Common Information Model) and CIM/G-based graphics-model-integrated apparatus and method for distribution network. The apparatus comprises an operating system for distribution systems, which is used by distribution network dispatcher and a debugging system for maintaining graphics and models. The operating system communicates with the debugging system via TCP/IP protocol, using the CIM/E Language to describe full models and incremental models of distribution network, and using the CIM/G Language to describe graphics of distribution network. This invention manages the graphics and models through the remote call, graphics-model-operation and graphics-model-rollback, achieves the management of the graphics and models of past, present and future. Through using dual systems including a debugging system and an operating system and by means of efficient exchange of CIM/E models and CIM/G graphics between the two systems, this invention realizes graphics and models update as well as rollback management, thereby improves the safety and accuracy of the graphics and models of distribution networks.

### CROSS REFERENCE TO RELATED APPLICATIONS

This application claims the benefit of People's Republic of China application Serial No. 201410331316.9, filed Jul. 11, 2014, under 35 USC Sec. 119(a), hereby specifically incorporated by reference in its entirely.

1. Field of the Invention

This invention relates to the field of electronic device, especially a CIM/E and CIM/G-based graphics-model-integrated apparatus and method for distribution network.

2. Description of the Related Art

Developed based on the Power System Common Information Model CIM of IEC61970-301, the grid common model description specification—the CIM/E Language Specification (hereinafter referred to as “the CIM/E Language”) is a new and effective power system information marking language aiming to overcome the inefficiency in description of CIM using the XML.

By integrating the traditional relationship-oriented information specification mode and the object-oriented CIM for power systems, the CIM/E Language not only maintains high efficiency of relationship-oriented methods and takes advantage of long-term research results thereof, but also absorbs the features of object-oriented methods, thereby presenting the features of briefness, effectiveness and suitability for describing and exchanging large-scale grid models.

To overcome the deficiency that the SVG (Scalable Vector Graphics)-based common graphics exchange format cannot directly express graphics-model integration of power systems, the graphics description specification for power systems—CIM/G Language Specification (hereinafter referred to as “the CIM/G Language”) is a new graphics description language developed based on graphics exchange of CIM of IEC 61970-453 and applicable for power systems. Graphics description specifications for power systems express related information of electrical equipment and grids in the form of graphics, support effective access to power graphics and model-related data, and support exchange of power graphics and model-related data among various systems.

However, the current SVG-based common graphics exchange format cannot directly express graphics-model integration of power systems.

### SUMMARY OF THE INVENTION

Regarding the above problems, this invention discloses a CIM/E and CIM/G-based graphics-model-integrated apparatus and method for distribution network, which realizes model management of past, current and future models by absorbing the advantages and features of the CIM/E and CIM/G Languages, using the CIM/E Language to describe full models and incremental models of distribution network, and using the CIM/G Language to describe graphics of distribution network. Parsing and storing in a database the graphics and models of distribution network using the CIM/E and CIM/G Languages, this invention is featured by briefness, effectiveness and suitability for describing and exchanging large-scale grid models. Through using dual systems including a debugging system and an operating system and by means of efficient exchange of CIM/E models and CIM/G graphics between the two systems, this invention realizes graphics and model update as well as rollback management, thereby improving the safety and accuracy of the graphics and models of distribution network.

This invention is realized by the following technical solutions:

A CIM/E and CIM/G-based graphics-model-integrated apparatus for a distribution network, comprising an operating system for distribution systems, which is used by distribution network dispatcher and a debugging system for maintaining graphics and models, the debugging system being the source of the graphics and model data of the operating system, the operating system communicating with the debugging system via a service interface.

Preferably, the communication of the service interface is performed using the TCP/IP protocol. A CIM/E and CIM/G-based graphics-model-integrated method for a distribution network, comprising the steps of:

S1: maintaining graphics and models in a debugging system, and regulating the maintained graphics and models; and

S2: remotely calling the graphics and models by an operating system, wherein if verification of the graphics and models is successful, the graphics and models are put into operation, and if unsuccessful, the graphics and models are rolled back.

Further, remotely calling the graphics and models by the operating system comprises the steps of:

A1: exporting an intermediate file of the graphics and models from the debugging system; and

A2: parsing, by the operating system, the intermediate file exported by the debugging system, not storing the intermediate file in a database, and displaying the intermediate file on a terminal for manual examination.

Further, putting the graphics and models into operation comprises the steps of:

B1: exporting an intermediate file of the graphics and models from the debugging system; and

B2: parsing, by the operating system, the intermediate file exported by the debugging system, and storing the intermediate file in a database.

Further, rolling back the graphics and models comprises the steps of:

C1: exporting an intermediate file of the graphics and models from the operating system; and

C2: parsing, by the debugging system, the intermediate file, and storing the intermediate file in a database.

Further, the intermediate files of the graphics and models are in the CIM/E format and CIM/G format, respectively.

This invention has the following beneficial effects: by parsing the graphics and models of a distribution network using the CIM/E and CIM/G Languages and storing the graphics and models in a database, this invention has the features of briefness, effectiveness and suitability for describing and exchanging large-scale grid models; through using dual systems including a debugging system and an operating system and by means of efficient exchange of CIM/E models and CIM/G graphics between the two systems, this invention realizes graphics and model update as well as rollback management, thereby improving the safety and accuracy of the graphics and models of distribution networks.

### BRIEF DESCRIPTION OF THE DRAWINGS

FIG. 1 is the schematic structural drawing of this invention.

### DESCRIPTION OF THE PREFERRED EMBODIMENTS

To further describe the technical characteristics and advantages of the invention, the accompanying drawings and the following specific embodiments of the present invention will be further described below.

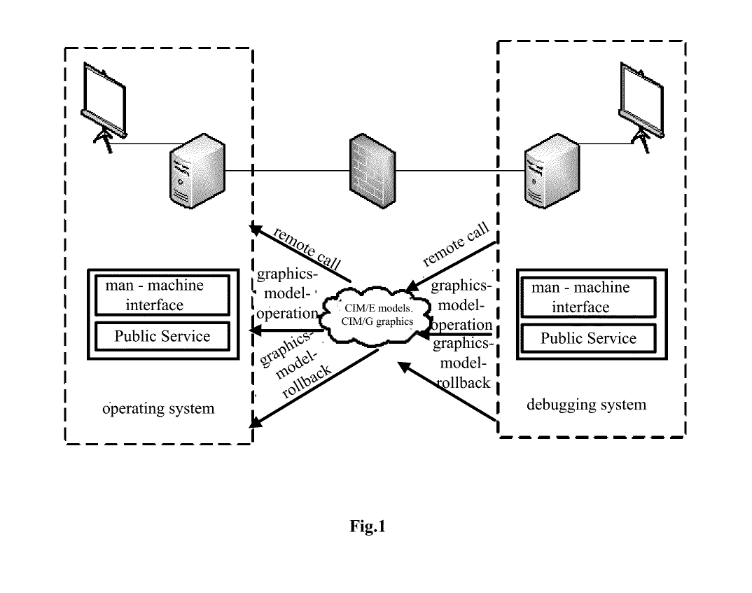

Referring to FIG. 1, a CIM/E and CIM/G-based graphics-model-integrated apparatus for a distribution network comprises an operating system, which is an actual distribution network management system, and a debugging system, which is a simplified distribution network management system, with a service interface enabling communication and processing call requests between the operating system and the debugging system. The operating system is an automatic power distribution system for distribution network dispatcher and has great significance, so it does not allow direct maintenance of the graphics and models. The debugging system, similar to the operating system, is used for maintenance of the graphics and models and serves as the source of the graphics and model data of the operating system. The two systems use different resources and data. Usually, when seen from the perspective of the operating system, the debugging system represents future graphics and models, while the operating system represents current ones. When seen from the perspective of the debugging system, the operating system represents current graphics and models, while the operating system represents past ones. The two systems communicate with each other via a service interface. When the two systems interact with each other, the output side of graphics and models exports and sequences model files in the CIM/E format and graphics files in the CIM/G format, and transmits the same to the counterpart service interface. The counterpart service interface reversely sequences the model files and graphics files, and converts them into model files in the CIM/E format and graphics files in the CIM/G format for processing.

When managing the graphics and models, they are maintained in the debugging system first. The maintenance method may be performed manually. For example, distribution network data may be input manually. Alternatively, graphics and model data of other sources may be exported. For example, graphics and models may be output from a production management system or a geographical information system and imported into the systems. On the completion of the test and debug, the operating system remotely calls and examines the graphics and model data. Scheduling users may remotely call the graphics and model data of the debugging system using the operating system. The system lists the actual operation data of the operating system and the newly added data of the debugging system in three types of data, namely, added data, deleted data and modified data, item by item. That is, the debugging system outputs the differentiated models in the CIM/E format and new graphics in the CIM/G format, and the operating system develops and displays the same on a human-machine interface for verification. If the verification is successful, the graphics and models will be put into operation. That is, the debugging system exports the models in the CIM/E format and graphics in the CIM/G format, and the operating system develops the models in the CIM/E format into SQL (Structured Query Language) sentences corresponding to a database, sequentially stores the SQL sentences in the database, develops the graphics in the CIM/G format into graphics objects corresponding to a graphics database, covers the old graphics and updates the association relationship between the graphics and models. If the user determines that any part of the models or graphics does not meet the actual needs for engineering practice, for example, if the graphics are wrongly drawn or the data is inaccurate, the verification will fail and the graphics and models will be rolled back. In other words, the operating system exports the model files in the CIM/E format and old graphics in the CIM/G format, and the debugging system develops the models in the CIM/E format into SQL sentences corresponding to a database, sequentially stores the SQL sentences in the database, develops the graphics in the CIM/G format into graphics objects corresponding to a graphics database, covers the new graphics and restores the models and graphics to their original state. The above embodiment is not intended to limit this invention in any form. Any technical solution obtained by equivalent substitution or modification should fall into the protection scope of this invention.

What is claimed is:

1. A CIM/E and CIM/G-based graphics-model-integrated apparatus for a distribution network, comprising an operating system for distribution systems, which is used by distribution network dispatcher and a debugging system for maintaining graphics and models, the debugging system being the source of the graphics and model data of the operating system, the operating system communicates with the debugging system via a service interface.

2. The CIM/E and CIM/G-based graphics-model-integrated apparatus as claimed in claim 1, wherein the service interface communication is performed using the TCP/IP protocol.

3. A CIM/E and CIM/G-based graphics-model-integrated method for a distribution network, comprising the steps of:
S1: maintaining graphics and models in a debugging system, and debugging the maintained graphics and models; and
S2: remotely calling the graphics and models by an operating system, wherein if verification of the graphics and models is successful, the graphics and models are put into operation, and if unsuccessful, the graphics and models are rolled back.

4. The CIM/E and CIM/G-based graphics-model-integrated method as claimed in claim 3, wherein remotely calling the graphics and models by the operating system comprises the steps of:
A1: exporting an intermediate file of the graphics and models from the debugging system; and
A2: parsing, by the operating system, the intermediate file exported by the debugging system, not storing the intermediate file in a database, and displaying the intermediate file on a terminal for manual examination.

5. The CIM/E and CIM/G-based graphics-model-integrated method as claimed in claim 3, wherein putting the graphics and models into operation comprises the steps of:
B1: exporting an intermediate file of the graphics and models from the debugging system; and
B2: parsing, by the operating system, the intermediate file exported by the debugging system, and storing the intermediate file in a database.

6. The CIM/E and CIM/G-based graphics-model-integrated method as claimed in claim 3, wherein rolling back the graphics and models comprises the steps of:
C1: exporting an intermediate file of the graphics and models from the operating system; and
C2: parsing, by the debugging system, the intermediate file, and storing the intermediate file in a database.

7. The CIM/E and CIM/G-based graphics-model-integrated method as claimed in one of 4-6 claims, wherein the intermediate files of the graphics and models are in the CIM/E format and CIM/G format, respectively.
